(19) United States
(12) Patent Application Publication
(10) Pub. No.: US 2023/0381992 A1
(43) Pub. Date: Nov. 30, 2023

(54) Method of Cutting a Running Web

(71) Applicant: ALLSTEIN GMBH, Herford (DE)

(72) Inventors: Gordon Whitelaw, Bielefeld (DE); Thomas Haecker, Marienfeld (DE)

(21) Appl. No.: 18/026,429

(22) PCT Filed: Aug. 10, 2021
(86) PCT No.: PCT/EP2021/072278

§ 371 Date: Mar. 15, 2023

(30) Foreign Application Priority Data
Nov. 25, 2020 (EP) 20209853.9

(51) Int. Cl. B26D 1/40; B26D 5/16; B26D 7/10

(52) U.S. Cl. CPC B26D 1/405; B26D 5/16; B26D 7/10

(57) ABSTRACT

A method of cutting a running web, including the steps of: training the web over a smooth peripheral surface of an anvil drum; rotating a blade that extends in an axial direction of the anvil drum about an axis of rotation that is parallel to the axis of the anvil drum; retaining the blade in a retracted position in which a cutting edge of the blade is spaced apart from the web on the anvil drum, the blade being retained against a biasing force of a pre-loading mechanism that biases the blade in a direction towards the axis of the anvil drum; and releasing the blade at a time calculated to assure that the blade will hit the web at a time when the blade passes through a plane that contains the axis of the anvil drum and the axis of rotation.

The invention relates to a method of cutting a running web.

When an endless web, e.g. a printed web exiting from a rotary printing press, is wound on a coil, the diameter of the coil gradually increases and when a certain maximum diameter has been reached, it is necessary to cut the web and to redirect the subsequent part of the web to another coil.

EP 1 454 858 B1 describes an example of a winder with an integrated cutting device wherein a chopper blade is moved so as to cut through a length of the web that is held under tension between two deflection rollers.

Depending upon the material and the transport speed of the web, it is sometimes difficult to perform a clean cut and to reliably catch the leading edge of the part of the web that has to be directed to the new coil.

It is an object of the invention to provide a robust and reliable cutting method.

In order to achieve this object, the invention proposes methods according to the independent claims 1 and 12, a cutter unit according to the independent claims 8 and 13, and a winder according to claim 14.

In one embodiment, the method according to the invention is characterized by the steps of:
training the web over a smooth peripheral surface of an anvil drum;
rotating a blade that extends in axial direction of the anvil drum about an axis of rotation that is parallel to the axis of the anvil drum;
retaining the blade in a retracted position in which a cutting edge of the blade is spaced apart from the web on the anvil drum, the blade being retained against a biasing force of a pre-loading mechanism that biases the blade in a direction towards the axis of the anvil drum; and
releasing the blade at a time calculated to assure that the blade will hit the web at a time when the blade passes through a plane that contains the axis of the anvil drum and said axis of rotation.

It has been found that even difficult web materials such as a plastic foil, for example, can be cut smoothly and reliably in a process in which the cutting blade does not cut through the web but only punches the web against a smooth surface of an anvil, provided that the blade is moved with sufficient speed while performing the punch. For that reason, the blade is held in a pre-loaded state and is then unlocked abruptly, so that the pre-loading mechanism will toss the blade against the web which is supported on the peripheral surface of the anvil drum such that the cutting edge of the blade will hit the web practically simultaneously over the entire width of the web. In order to avoid any substantial relative movement of the blade and the web during the cutting process, the blade is rotated about its axis of rotation with appropriate angular velocity, so that the web and the cutting edge of the blade have equal translational speeds at least in the moment in which the rotating blade is facing the web and is abruptly moved against the web in radial direction of the anvil drum. In this way, the web can reliably be severed along a smooth and straight cut line.

Although it is stated in claim 1 that the axis of rotation of the blade is parallel to the axis of the anvil drum, a high accuracy of the parallelism is not required. for example, an angular deviation of up to 5° ma be acceptable.

In another embodiment, the blade is heated to an elevated temperature. In this case, the cutting mechanism may be simplified by omitting the pre-loading step.

Useful details and further developments of the invention are indicated in the dependent claims.

It is a particular advantage of the invention that the leading edge of the part of the cut web that is to be wound onto the new coil is supported on the peripheral surface of the anvil drum at the moment at which the cut is performed. Thus, the leading edge of the web can be caused to stick to the surface of the drum, e.g. by suction, so that it may safely be guided to a circumferential position of the drum where the drum contacts the periphery of a reel on which the new coil of the web material is to be formed.

The axis of rotation of the blade may be formed by a rotating shaft which supports the blade on its entire length in a position in which it projects radially outwardly from the surface of the shaft.

The abrupt punch-like movement of the blade against the web may be a radial movement of the blade relative to the shaft in which the pre-loading mechanism is integrated. In a preferred embodiment, however, the blade is rigidly mounted on the shaft and the pre-loading mechanism acts upon the shaft and the blade as a whole, so that the rigidity of the shaft can be utilized to stabilize the blade on its entire length.

A cam mechanism may be provided for retaining the blade and the shaft in the pre-loaded state. For example, the cam may be a rotatable eccentric cam which has a spiral shaped outer periphery with a radial step at one particular circumferential position. Then, a member supporting the shaft may be urged against the cam and may have a stepped contour that engages the peripheral surface of the cam. As long as the stepped contour of the support member rests on a peripheral portion of the cam where the radius of the eccentric cam is close to its maximum, the shaft and the blade will be in a locked state. In order to unlock the shaft and blade, the cam is rotated to a position where the stepped contour of the support member slips off the step of the cam, so that the pre-loading mechanism can abruptly push the shaft and the blade against the anvil drum. Then, when the cam is rotated further, the support member will gradually be moved outwardly, so that the pre-load mechanism is loaded again until the stepped portion of the support approaches again the step of the cam.

An embodiment example will now be described in conjunction with the drawings, wherein:

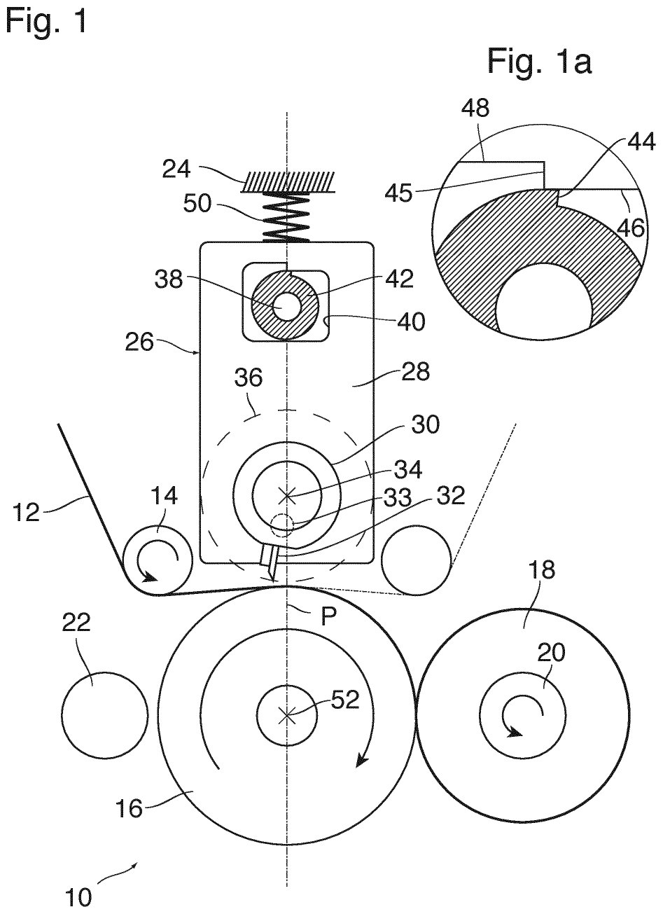

FIG. 1 is a schematic side view of a winder having a cutter unit;

FIG. 1a shows an enlarged detail of FIG. 1;

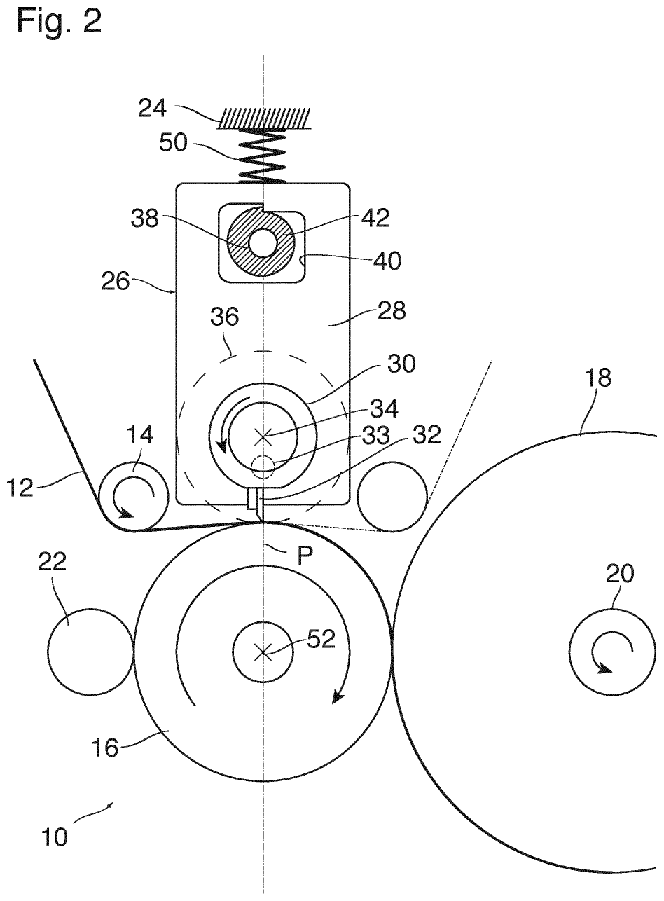

FIG. 2 shows the winder and the cutter unit in a state in which a cutting operation is performed; and

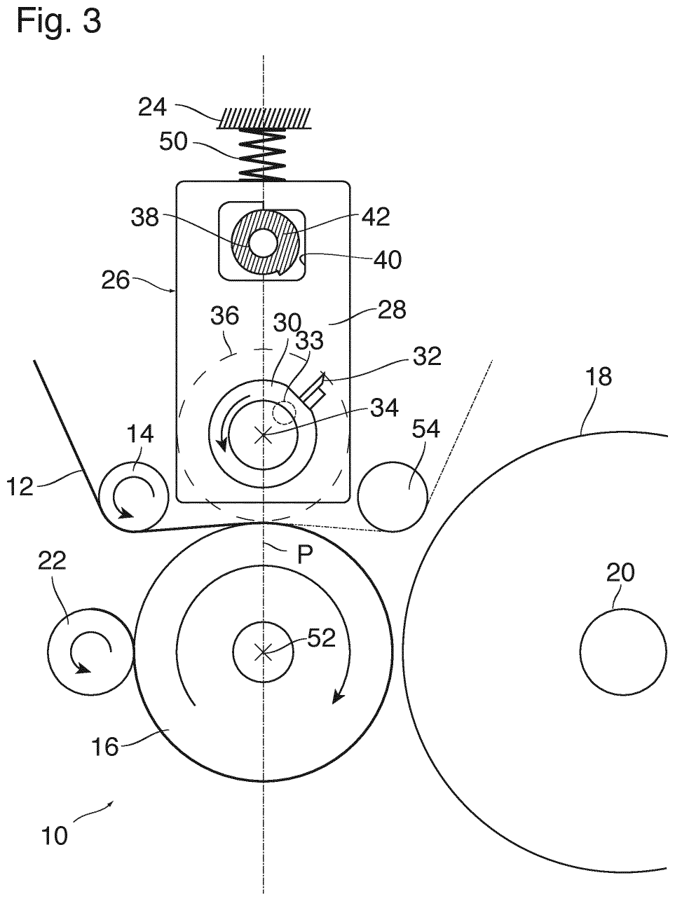

FIG. 3 shows the winder and the cutter unit in a later stage of operation.

FIG. 1 schematically shows a winder 10 that may be installed in a rotary printing press for winding an endless web 12 of a print substrate. The web 12 is passed over a deflection roller 14 and is then trained around a part of a smooth peripheral surface of an anvil drum 16 and is eventually wound on a coil 18 on a first reel 20. The anvil drum 16, the first reel 20 and a second reel 22 are rotatably supported in a machine frame 24 of which only a top wall has been shown symbolically in the drawing.

The anvil drum 16 forms part of a cutter unit that further comprises a cutter rig 26 that is guided for vertical movement in the machine frame. The cutter rig 26 has a side frame 28 that rotatably supports one end of a shaft 30. An opposite end of the shaft 30 is supported in another side frame which has not been shown in the drawing. A blade 32 is rigidly mounted on the shaft 30 so as to extend in longitudinal direction of the shaft and to project radially from the surface of the shaft. A blade holder portion inside the shaft has an integrated heating cartridge 33 for heating the blade 32 to a temperature of about 150° C. When the shaft and the blade 32 rotate about an axis of rotation 34 of the shaft, a cutting edge of the blade 32 moves along a circular trajectory 36. In the condition shown in FIG. 1, this trajectory is separated from the top vertex of the anvil drum 16 by a small gap.

A cam shaft 38 is rotatably supported in the machine frame and extends through respective windows 40 formed in each of the two side frames 28. In each of these windows 40, the cam shaft 38 carries an eccentric cam 42 that has a spiral-shaped outer peripheral surface forming a step 44 at one point of its periphery, as can be seen more clearly in FIG. 1a. A top wall of the window 40 has a stepped contour comprising a vertical step that divides this top wall into a lower section 46 and an upper section 48 as has also been shown in FIG. 1a. The lower section 46 of the top wall of the windows 40 engages the peripheral surface of the cam 42, whereby the entire cutter rig 26 is locked in the position shown in FIG. 1 against the biasing force of a pre-loading mechanism 50 (symbolized by a spring that is supported at the top wall of the machine frame 24).

In the condition shown in FIG. 1, while the web 12 is wound onto the reel 20, both, the shaft 30 and the cam shaft 38 are held stationary, so that the cutter unit is inactive, except that the rotating anvil drum 16 participates in guiding the web onto the coil 18.

As the winding process continues, the coil 18 will gradually grow in diameter, and, consequently, the reel 20 has to be moved laterally away from the axis 52 of the anvil drum 16. When the diameter of the coil 18 reaches a certain maximum value, it is necessary to cut the web 12 and to direct the subsequent portion of the web onto the empty second reel 22 so as to start forming a new coil on that reel.

Shortly before that moment in time is reached, the shaft 30 is driven for rotation and accelerated to an angular velocity at which the circumferential speed of the cutting edge of the blade 32 matches the peripheral speed of the anvil drum. Then, when the blade 32 approaches the vertical plane P that contains the axis 52 of the anvil drum and the axis of rotation 34 of the shaft 30, the cam shaft 38 is also driven for anti-clockwise rotation in FIG. 1. As a consequence, the lower section 46 of the top wall of the window 40 will slip off the step 44 of the cam, as has been shown in FIG. 2. As a consequence, the entire cutter rig 26 will quickly be accelerated downwards under its own gravitational force and under the force of the pre-loading mechanism 50. Then, after a very short time, the cutting edge of the blade 32 will hit the web 12 on the smooth surface of the anvil drum 16. At this moment, the downward movement of the cutter rig 26 is stopped by the lower wall section 46 abutting on the peripheral surface of the cam. The timing of the rotation of the cam shaft is controlled such that the cutting edge of the blade 32 will hit the web 12 at the moment when the blade passes through the vertical plane P. The stop position for the cutter rig 26 is adjusted such that the blade 32 will cut into the thickness of the web 12 by a sufficient amount to severe the web, so that the leading part and the trailing part of the web are separated, without the blade causing damage to the anvil drum 16. Optionally, the surface of the anvil drum may have a rubber-elastic coating. It will be understood that the elevated temperature of the blade that has been heated by the heating cartridge 33 assists in severing the web.

FIG. 3 shows the situation in a somewhat later stage. The shaft 30 has continued its rotation and will be stopped in an appropriate position so as to be ready for another cutting process. The first reel 20 carrying the coil 18 has been moved away from the anvil drum 16 whereas the second reel 22 (to which a swath of adhesive may have been applied in order to attach the leading edge of the web 12) has been set against the peripheral surface of the anvil drum 16 at a time when the leading edge of the cut web 12 has reached the nip between the reel 22 and the anvil drum, so that a new coil will now be formed under the second reel 22. During the time in which the leading edge of the web has moved from the cut position (at the top vertex of the anvil drum) to the nip of the second reel 22, the web has been attracted to the peripherals surface of the anvil drum by a suction pressure applied to the web via perforations in the surface of the drum.

In FIG. 3, the cam shaft 38 is still being driven for rotation, so that the spiral-shaped surface of the cam 42 will push the cutter rig 26 upwards and tension the pre-loading mechanism 50. The rotation of the cam shaft 38 will be stopped when the position shown in FIG. 1 has been reached again.

The coil 18 will be removed from the first reel 20 and the first reel will be approached towards the anvil drum 16 again so as to be ready to take up another coil. When the coil being formed on the second reel 22 reaches its maximum diameter, the cutter unit is activated again, so as to start a new coil on the first reel 20.

While, in the example that has been described here, the reels 20 and 22 are moved counter-clockwise, it is also possible to operate the winder 10 in a mode in which the reels are rotated clockwise. In that mode of operation, the web 12 is fed from the opposite side via a deflection roller 54, and the sense of rotation of the anvil drum 16 and the shaft 30 is reversed.

What is claimed is:

1. A method of cutting a running web, comprising the steps of:
training the web over a smooth peripheral surface of an anvil drum having an axis;
rotating a blade that extends in an axial direction of the anvil drum about an axis of rotation that is parallel to the axis of the anvil drum;
retaining the blade in a retracted position in which a cutting edge of the blade is spaced apart from the web on the anvil drum, the blade being retained against a biasing force of a pre-loading mechanism that biases the blade in a direction towards the axis of the anvil drum; and
releasing the blade at a time calculated to assure that the blade will hit the web at a time when the blade passes through a plane that contains the axis of the anvil drum and said axis of rotation.

2. The method according to claim 1, wherein further including the step of controlling the circumferential speed of the blade to match the circumferential speed of the anvil drum at the time when the blade hits the web.

3. The method according to claim 1, wherein the blade is rigidly mounted on a rotatable shaft that is supported in a cutter rig, and further including the step of arranging the pre-loading mechanism to act upon the cutter rig.

4. The method according to claim 3, wherein said plane that contains the axis of the anvil drum and the axis of rotation is a vertical plane and further including the step of biasing the cutter rig downwards.

5. The method according to claim 3, further including the step of locking the cutter rig against the force of the pre-loading mechanism by a cam mechanism.

6. The method according to claim 5, wherein the cam mechanism comprises a cam with a spiral-shaped peripheral surface and a radial step at one point of its periphery, the cutter rig being locked by a stepped contour of the cutter rig engaging the cam, and further including the step of rotating the cam to unlock the cutter rig when the stepped contour slips off the step of the cam.

7. The method according to claim 1, further including the step of keeping the blade at an elevated temperature.

8. A cutter unit for use with a rotating anvil drum having an axis and a smooth peripheral surface for supporting a web, the cutter unit comprising:
a blade for cutting a running web, the blade being adapted to be driven for rotation about an axis of rotation that extends in parallel with the axis of the anvil drum, and the blade mounted in a cutter rig,
a pre-loading mechanism arranged to bias the blade against the web on the anvil drum, and
a retaining mechanism for retaining the blade against a biasing force of the pre-loading mechanism that is arranged to bias the blade against the web on the anvil drum, the retaining mechanism being arranged to abruptly release the cutter rig, whereby the blade is accelerated against the web.

9. The cutter unit according to claim 8, wherein:
the blade is rigidly mounted on a shaft that is rotatably supported in the cutter rig, and
the pre-loading mechanism and the cam mechanism are arranged to act upon the cutter rig.

10. The cutter unit according to claim 8, wherein:
the retaining mechanism comprises a rotatable cam having a spiral-shaped peripheral surface with a radial step at one position of its periphery, and
a support member of the cutter rig has a stepped contour held in engagement with the peripheral surface of the cam.

11. The cutter unit according to claim 8, further comprising a heating system arranged to heat the blade.

12. A method of cutting a running web, comprising the steps of:
training the web over a smooth peripheral surface of an anvil drum having an axis;
rotating a blade that is heated to an elevated temperature and extends in an axial direction of the anvil drum, about an axis of rotation that is parallel to the axis of the anvil drum; and
advancing the blade against the anvil drum at a time calculated to assure that the blade will hit the web at a time when the blade passes through a plane that contains the axis of the anvil drum and the axis of rotation.

13. A cutter unit for use with a rotating anvil drum having an axis and a smooth peripheral surface for supporting a web, the cutter unit comprising:
a blade for cutting a running web, the blade being adapted to be driven for rotation about an axis of rotation that extends in parallel with the axis of the anvil drum,
a heating system arranged to heat the blade, and
an actuating mechanism for advancing the blade against the web on the anvil drum, whereby the web is severed by the blade.

14. A winder for winding a web onto a coil, comprising the cutter unit according to claim 8.

15. The winder according to claim 14, comprising first and second reels disposed on opposite sides of said anvil drum, said reels being adjustable between an active position and an inactive position for alternatingly forming a coil on a respective one of said reels.

16. The winder according to claim 14, wherein the direction of rotation of the anvil drum is reversible and further comprising a feed mechanism configured to selectively feed the web towards the anvil drum from opposite sides.
